(19) United States
(12) Patent Application Publication
(10) Pub. No.: US 2013/0279750 A1
(43) Pub. Date: Oct. 24, 2013

(54) IDENTIFICATION OF FOREIGN OBJECT DEBRIS

(71) Applicant: DMETRIX, INC., Tucson, AZ (US)

(72) Inventors: Pixuan Zhou, Tucson, AZ (US); Lu Ding, Tucson, AZ (US); Xuemeng Zhang, Tucson, AZ (US)

(73) Assignee: DMetrix, Inc., Tucson, AZ (US)

(21) Appl. No.: 13/861,121

(22) Filed: Apr. 11, 2013

Related U.S. Application Data
(60) Provisional application No. 61/636,573, filed on Apr. 20, 2012.

(51) Int. Cl. G06T 7/00

(52) U.S. Cl. CPC G06T 7/0002
USPC 382/103

(57) ABSTRACT

System and method for identification of foreign object debris, FOD, in a sample, based on comparison of edge features identified in images of the sample takes at a reference point in time and at a later time (when FOD may be already present). The rate of success of identification of the FOD is increased by compensation for relative movement between the imaging camera and the sample, which may include not only processing the sample's image by eroding of imaging data but also preceding spatial widening of edge features that may be indicative of FOD.

### CROSS-REFERENCE TO RELATED APPLICATIONS

This application claims the benefit of and priority from the U.S. Provisional Patent Application No. 61/636,573 filed on Apr. 20, 2012 and titled “Method to Identify Foreign Matter in Images”, the entire contents of which are hereby incorporated by reference for all purposes.

### TECHNICAL FIELD

The present invention relates to systems and methods for identification of foreign matter in images and, in particular, to a system and method enabling identification of foreign object debris in a sample under test based on image-based identification of edges associated with the sample.

### BACKGROUND ART

As used in this application, the term foreign object debris (FOD) refers to a substance, debris or article alien to (that is, not part of) an objector sample under test that could potentially cause damage to the object or sample. FIG. 1 presents, as an illustration, an image of FOD-attributed damage to a Lycoming turboshaft engine in a Bell 222U helicopter with a small object that is qualified as FOD (available at http://en.wikipedia.org/wiki/Foreign_object_damage).

Examples of FOD that cause a serious hazard in airspace related industry include, for example, tools left inside the machine or system (such as an aircraft) after manufacturing or servicing, that can get tangled in control cables, jam moving parts, short out electrical connections, or otherwise interfere with safe flight. In area of general manufacture, examples of FOD include defects in a mold used for mass-fabrication of a particular element. These defects (such as chippings off of the surface or edges of the mold, or debris stuck to the mold surface, or holes and/or indentations in the surface of the mold) could render the fabricated element defective or even inoperable for the purposes of intended operation.

Visual inspection of the region of interest and verification of involved procedures (such as packaging, handling, shipping and storage containers) to ensure that nicks, dents, holes, abrasions, scratches, and burns, for example, which may be detrimental to the function and integrity of a part or assembly are not present is an expensive and operationally involved proposition. Grease, preservatives, corrosion products, weld slag, shop and other dirt, and other materials such as dirt, grime, debris, metal shavings or filings foreign to the item may or may not appear at any step of manufacture or operation of a given device or system.

Reliable identification of FOD in various objects remains an important problem that still requires a solution.

### SUMMARY OF THE INVENTION

Embodiments of the invention provide for a method for determining a foreign object debris (FOD) associated with a sample, which method includes acquisition of reference image data (with a detector of an imaging system) that represents a reference sample to form a reference image. The method further includes forming an image of the reference sample representing a position of an edge associated with the reference sample based on (i) a first image of said reference sample representing a first change of irradiance distribution associated with said reference sample and (ii) a second image of said reference sample representing a second change of irradiance distribution associated with said reference sample, the first and second changes occurring in mutually transverse directions. The method may additionally include a step of converting the image of the reference sample representing a position of an edge associated with the reference sample into a binary image of the reference sample, where the binary image contains edges (associated with the reference sample) on a substantially uniform background. The method also includes forming an image of a stale sample, which image represents a position of an edge associated with the stale sample, based on (i) a first image of the stale sample and (ii) a second image of the stale sample. Here, the first image represents a first change of irradiance distribution associated with the stale sample and the second image represents a second change of irradiance distribution associated with the stale sample, the first and second changes occurring in mutually transverse directions. The method further includes the steps of (a) forming a comparison image of the sample (which comparison image is devoid of an edge that is associated with both the reference sample and the stale sample) based on the binary image of the reference sample and the image of the stale sample, and (b) determining if the FOD is present at the stale sample by compensating the comparison image for a relative movement between the stale sample and the imaging system and comparing pixel irradiance values of the comparison image with a predetermined threshold value.

In a related embodiment, the method may additionally include a step of spatially widening of at least one edge associated with the reference sample by convolving, in two-dimensions, a chosen matrix with a matrix representing the binary image of the reference sample and/or a step of size-filtering of the FOD the presence of which has been determined. In a specific embodiment, the step of converting the image of the reference sample into a binary image includes assigning an irradiance value of zero to pixels of edges associated with said reference sample and an irradiance value of one to remaining pixels of the image of the reference sample representing a position of an edge associated with the reference sample.

Embodiments of the present invention also provide a related method for determining a foreign object debris (FOD) associated with a sample. Such method includes a step of acquisition, with a detector of an imaging system, of reference image data representing the reference sample to form a reference gradient image, of the reference sample. Each pixel of such reference gradient image is associated with a value of a two-dimensional (2D) gradient of irradiance distribution across the reference sample. The method further includes a step of determining reference edge image data representing a position of an edge associated with the reference sample based on the reference gradient image data. Additionally, the method involves forming a reference binary image data by (i) assigning a first value to first pixels of the reference gradient image data that correspond to the edge associated with the reference sample, and (ii) assigning a second value to the remaining pixels of the reference gradient image, the second value being different from the first value. The method further contains a step of forming an inverted reference binary image by defining a negative of the reference binary image created from the reference binary image data, and a step of forming an image of the stale sample that displays an edge associated with the stale sample, where such forming is based on acquisition of an image of the stale sample with the imaging system and determination of a 2D-gradient of irradiance distribution associated with the acquire image of the stale sample. Furthermore, the method includes combining, with a processing unit, the inverted reference binary image with the image of the stale sample to form a comparison image such that the comparison image is devoid of an edge that is associated with both the reference sample and the stale sample.

In a related embodiment, the method may further include at least one of the steps of (i) applying a low-pass filter to the comparison image to form a resulting low-frequency image, (ii) mapping a resulting low-frequency image into a segmented binary image based on pixel-by-pixel comparison between the resulting low-frequency image and a predetermined threshold value, and (iii) two-dimensionally convolving a data matrix representing the segmented binary image with an image erosion matrix, and (iv) widening of at least one edge associated with the reference sample by convolving, in two-dimensions, a chosen matrix with a matrix representing the reference binary image. An edge associated with the FOD is extracted from the comparison image that has been compensated for a relative movement between the imaging system and the stale sample. The so-identified FOD can be disregarded when a size of the FOD (calculated based on the extracted edge of the FOD) falls outside of a pre-determined range of values of interest.

In a specific embodiment of the invention, the step of determining reference image data may includes identifying first data points the values of which exceed a mean irradiance value associated with the reference gradient image. Alternatively or in addition, determining reference edge image data includes determining reference edge image data based on the reference gradient image converted to represent a gray-scale image of the reference sample. Alternatively or in addition, the step of forming of an inverted reference binary image may include defining a negative of the reference binary image in which each edge associated with the reference sample has been spatially widened.

Embodiments of the invention provide for a method for determining a foreign object debris (FOD) associated with a sample, which method includes acquisition of reference image data (with a detector of an imaging system) that represents a reference sample to form a reference image. The method further includes forming an image of the reference sample representing a position of an edge associated with the reference sample based on (i) a first image of said reference sample representing a first change of irradiance distribution associated with said reference sample and (ii) a second image of said reference sample representing a second change of irradiance distribution associated with said reference sample, the first and second changes occurring in mutually transverse directions. The method may additionally include a step of converting the image of the reference sample representing a position of an edge associated with the reference sample into a binary image of the reference sample, where the binary image contains edges (associated with the reference sample) on a substantially uniform background. The method also includes forming an image of a stale sample, which image represents a position of an edge associated with the stale sample, based on (i) a first image of the stale sample and (ii) a second image of the stale sample. Here, the first image represents a first change of irradiance distribution associated with the stale sample and the second image represents a second change of irradiance distribution associated with the stale sample, the first and second changes occurring in mutually transverse directions. The method further includes the steps of (a) forming a comparison image of the sample (which comparison image is devoid of an edge that is associated with both the reference sample and the stale sample) based on the binary image of the reference sample and the image of the stale sample, and (b) determining if the FOD is present at the stale sample by compensating the comparison image for a relative movement between the stale sample and the imaging system and comparing pixel irradiance values of the comparison image with a predetermined threshold value.

In a related embodiment, the method may additionally include a step of spatially widening of at least one edge associated with the reference sample by convolving, in two-dimensions, a chosen matrix with a matrix representing the binary image of the reference sample and/or a step of size-filtering of the FOD the presence of which has been determined. In a specific embodiment, the step of converting the image of the reference sample into a binary image includes assigning an irradiance value of zero to pixels of edges associated with said reference sample and an irradiance value of one to remaining pixels of the image of the reference sample representing a position of an edge associated with the reference sample.

### BRIEF DESCRIPTION OF THE DRAWINGS

The invention will be more fully understood by referring to the following Detailed Description in conjunction with the Drawings, of which:

FIG. 1 is an image of an often occurring FOD;

FIG. 2 is a diagram schematically representing a system of the invention;

FIG. 3 is a flow-chart depicting selected steps of an embodiment of the method of the invention;

FIG. 4 is a flow-chart providing details of an embodiment of the method of the invention;

FIG. 5 is a flow-chart providing additional details of a related embodiment of the method of the invention;

FIG. 6 is a flow-chart providing further details of a related embodiment of the method of the invention;

FIGS. 7A and 7B are images of the reference and stale samples, respectively (the stale sample characterized by an FOD);

FIGS. 7C and 7D are gray-scale images respectively corresponding to the images of FIGS. 7A, 7B;

FIGS. 7E and 7F are images of the reference and stale samples, respectively, showing two-dimensional distribution of gradient of irradiance across the corresponding samples;

FIG. 8 illustrates a positive binary image representing edge(s) associated with the reference sample;

FIG. 9 illustrates a positive image of FIG. 8 in which the edge(s) have been widened, according to an embodiment of the invention;

FIG. 10 illustrates a negative, inverted binary image of the reference sample obtained from the image of FIG. 9;

FIG. 11 is an image presenting edge features of the stale sample on a substantially uniform background;

FIG. 12 is a segmented image obtained from the image of FIG. 11 by removing high-frequency spatial noise;

FIG. 13 is an image identifying the FOD of the stale sample as a result of processing, according to an embodiment of the invention, to compensate for relative movement between the sample being imaged as an imaging system

FIGS. 14A and 14B provide examples of images of chosen reference and stale samples acquired with an imaging system of the invention, the stale sample containing an FOD;

FIGS. 15A, 15B are gray-scale image images corresponding to the images of FIGS. 14A, 14B;

FIG. 16 is an image identifying edge-features of the chosen reference sample of FIG. 14A according to an embodiment of the invention;

FIG. 17 is a positive binary image corresponding to the image of FIG. 16;

FIG. 18 is the positive image of FIG. 17 in which the edge-features have been spatially widened according to an embodiment of the invention;

FIG. 19 is a negative (inverted) binary image representing the reference sample of FIG. 14A;

FIG. 20 is an image identifying edge-features of the chosen stale sample of FIG. 14B according to an embodiment of the invention;

FIG. 21 is an image formed from the image of FIG. 20 by implementing an edge-subtraction step of the embodiment of the invention and identifying a suspect FOD;

FIG. 22 is the image of FIG. 21 from which the high-spatial frequency noise has been removed;

FIG. 23 is the image of FIG. 22 that has been segmented according to an embodiment of the invention;

FIG. 24 is an image positively identifying the FOD of the stale sample of FIG. 14B after compensation for relative movement between the sample and the imaging system of the invention has been performed accruing to an embodiment of the invention.

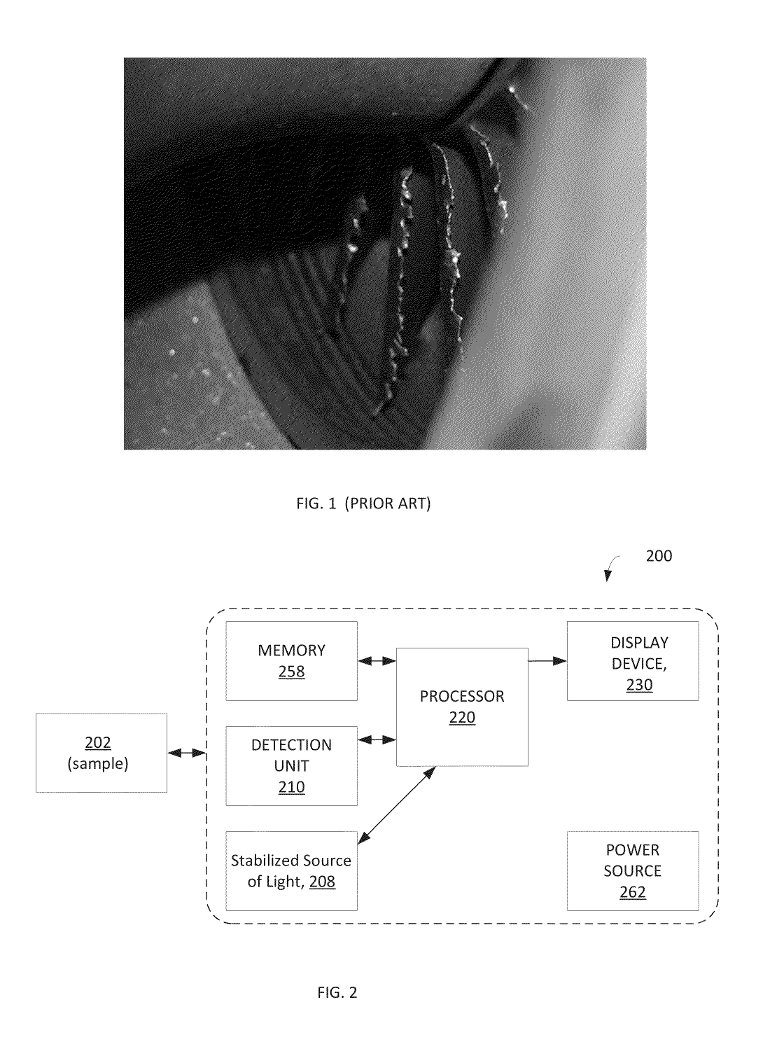

### DETAILED DESCRIPTION

Identification of foreign objects with the use of optical methods proved to be rather challenging as well at least in that in practice, there may occur at least some relative position shifting or rotation between an imaging system (for example, a video camera) and an object or sample being monitored during the monitoring, the results of which, detected in an stream of images, is often erroneously interpreted as the presence of the FOD. Similarly, the algorithms used for identification of the FOD are sometimes susceptible to interpreting changes in lighting/illumination conditions and/or shadow(s) cast on images as FOD. For example, identification of the FOD that is done under conditions of ambient illumination (such as natural light) is substantially disadvantageous for the purposes of the certainty of identification of the FOD, because ambient illumination may and often does unpredictably change as time goes on.

Embodiments of the present invention provide a method for reliable identification of FOD associated with the sample that has not contained any FOD at a reference point in time and determination of whether the identified FOD should be addressed or dealt with or if the identified FOD can be treated as noise (for the purposes of continued safe and reliable operation of the sample). To achieve this goal, the method of the invention preferably employs an appropriately chosen illumination conditions (for example, illumination with infrared, IR, light delivered from the chosen artificial source of light the operation of which is stabilized, both electrically and thermally). The method of the invention involves screening all edges in the first image of the reference sample (i.e., the image of the sample acquired at a reference point in time) and a second image of the sample acquired at a time that is later than the reference point in time. The sample at any time point in time that is later than the reference point in time is referred to as stale sample. The elimination of all edges in an image of the stale object that were not present in the image of the reference object is followed by data processing that ensures that image features attributed to changes in the sample that qualify as operational noise do not affect a decision of whether the FOD is or is not of significance. To this end, the image of the stale object is segmented, passed through an erosion process, and finally check against the threshold size/dimensions of the FOD that are of interest to the user. The propose algorithm can be implemented in surveillance-related applications, processes utilizing machine vision, as well as medical imaging, to name just a few.

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention.

In addition, the following disclosure may describe features of the invention with reference to corresponding drawings, in which like numbers represent the same or similar elements wherever possible. In the drawings, the depicted structural elements are generally not to scale, and certain components are enlarged relative to the other components for purposes of emphasis and understanding. No single drawing is intended to support a complete description of all features and details of the invention. Nevertheless, the presence of such details and feature in the drawing may be implied unless the context of the description requires otherwise. In other instances, well known structures, details, materials, or operations may be not shown in a given drawing or described in detail to avoid obscuring aspects of an embodiment of the invention that are being discussed.

If the schematic flow chart diagram is included in the disclosure, the depicted order and labeled steps of the logical flow thereof are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Without loss of generality, the order in which processing steps or particular methods occur may or may not strictly adhere to the order of the corresponding steps shown.

FIG. 2 illustrates schematically an example of imaging system 200 facilitating acquisition of image data from the sample 202 according to an embodiment of the present invention. Here, the imaging system 200 preferably includes operationally stabilized source of light (such as IR light, for example) 208 that may be used to illuminate the sample 202 under test to ensure the substantially homogeneous and/or unchanging illumination conditions. The imaging system 202 further includes an (optical) detection unit 210 such as a video camera, for example, and a pre-programmed processor 220 governing image acquisition and processing of the acquired image data, as well as creation of a visually perceivable representation of the sample 202, on a display device 230 (which includes any device providing visually-perceivable representation of an image of the sample under test and/or of the results of the imaging data processing; for example a monitor or a printer). The processor 220 may be realized by one or more microprocessors, digital signal processors (DSPs), Application-Specific Integrated Circuits (ASIC), Field-Programmable Gate Arrays (FPGA), or other equivalent integrated or discrete logic circuitry. At least some of the programming information may be received externally through an input/output (I/O) device (not shown) from the user. The I/O device can be also used to adjust relevant threshold parameters and figures of merit used in an algorithm of the invention. When system 200 boots up, it is also responsible for configuring all ports and peripherals connected to it. When implemented wirelessly, the camera 210 may be equipped with a special sub-system enabling an exchange of information with the processor 220 via radio frequency (RF) communication, for example.

A tangible non-transitory computer-readable memory 258 may be provided to store instructions for execution by the processor 220 and for storage of optically-acquired and processed imaging data. For example, the memory 258 may be used to store programs defining different sets of image parameters and threshold reference figures of merit. Other information relating to operation of the system 200 may also be stored in the memory 258. The memory 658 may include any form of computer-readable media such as random access memory (RAM), read only memory (ROM), electronically programmable memory (EPROM or EEPROM), flash memory, or any combination thereof. A power source 262 delivers operating power to the components of the system 200. The power source 262 may include a rechargeable or non-rechargeable battery or an isolated power generation circuit to produce the operating power.

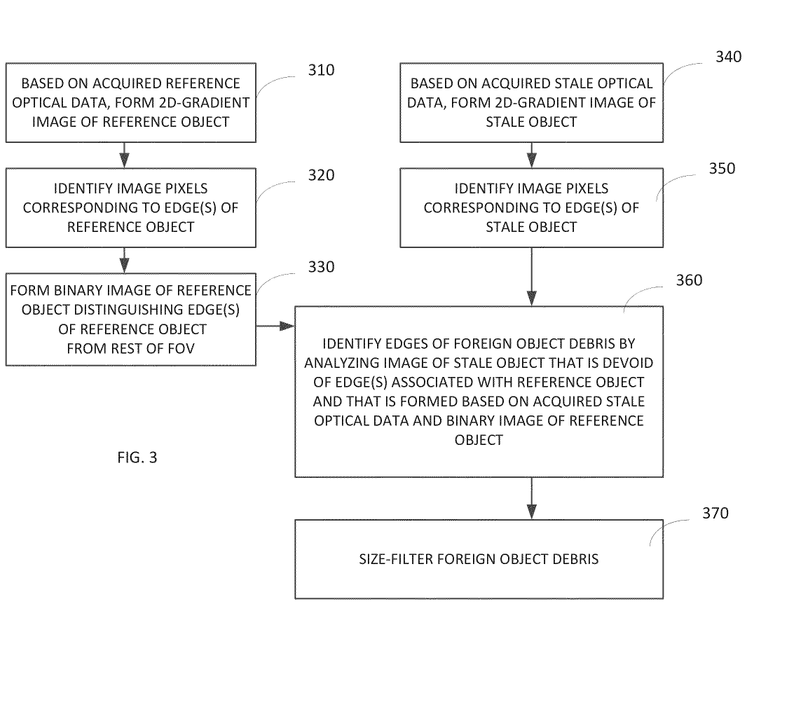

An embodiment of the method of invention is further discussed in reference to FIGS. 3 through 6.

### Initial Processing of Data Representing Reference and Stale Samples.

As shown in FIG. 3, to initiate the process of determination of the FOD at the sample, at step 310 the reference SUT is imaged (at the time when no FOD is known to be present) with the camera under the pre-determined illumination conditions and an image of the reference sample is formed, with the processor 220 of FIG. 2, that includes two-dimensional (2D) distribution of gradient of irradiance across the imaged surface of the reference SUT. Such image is referred to as a 2D-gradient image of the reference sample.

Using such image (referred to as a 2D-gradient image of the reference sample), image pixels are identified, step 320, that correspond to edges of the imaged reference sample. Taking into account image pixels that correspond to edge(s) of the imaged sample, a binary image of the reference sample is then formed at step 330 that represents the edge(s) of the reference sample on the image background that is covered by the field-of-view (FOV) of the optical system of the detection unit 210.

The method of the invention additionally requires to take an image of the sample under test at a different moment in time (comes after the moment of time when the reference optical data has been taken). The sample—now referred to as “stale sample” that may contain a sought after FOD—is, again, imaged at step 340 and the imaging data representing the stale sample is processed at step 350 in a fashion similar to that of step 320 to identify image edges present in the image corresponding to the stale sample.

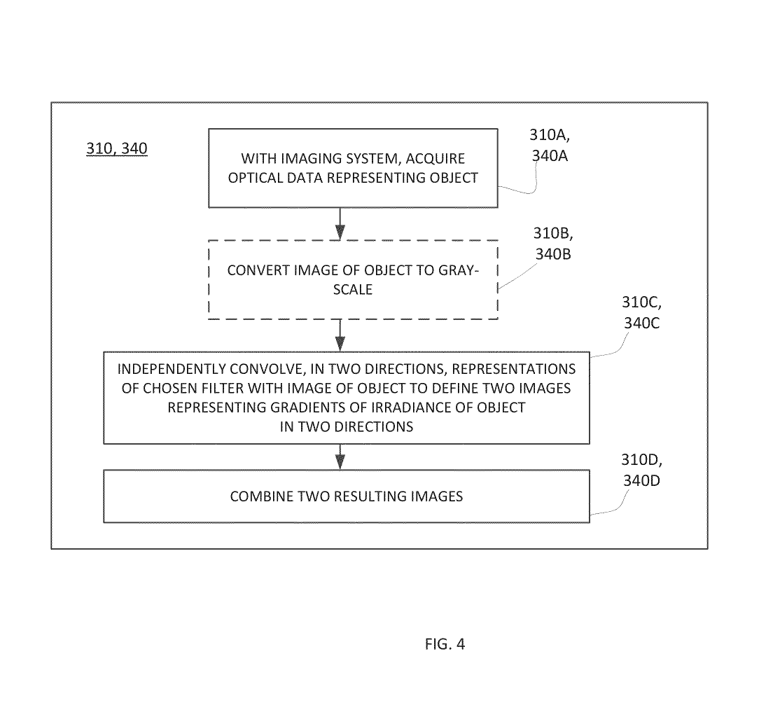

Optional sub-steps of the method of the invention related to steps 310 through 330 and 340, 350 of FIG. 3 are now discussed in detail in reference to FIG. 4.

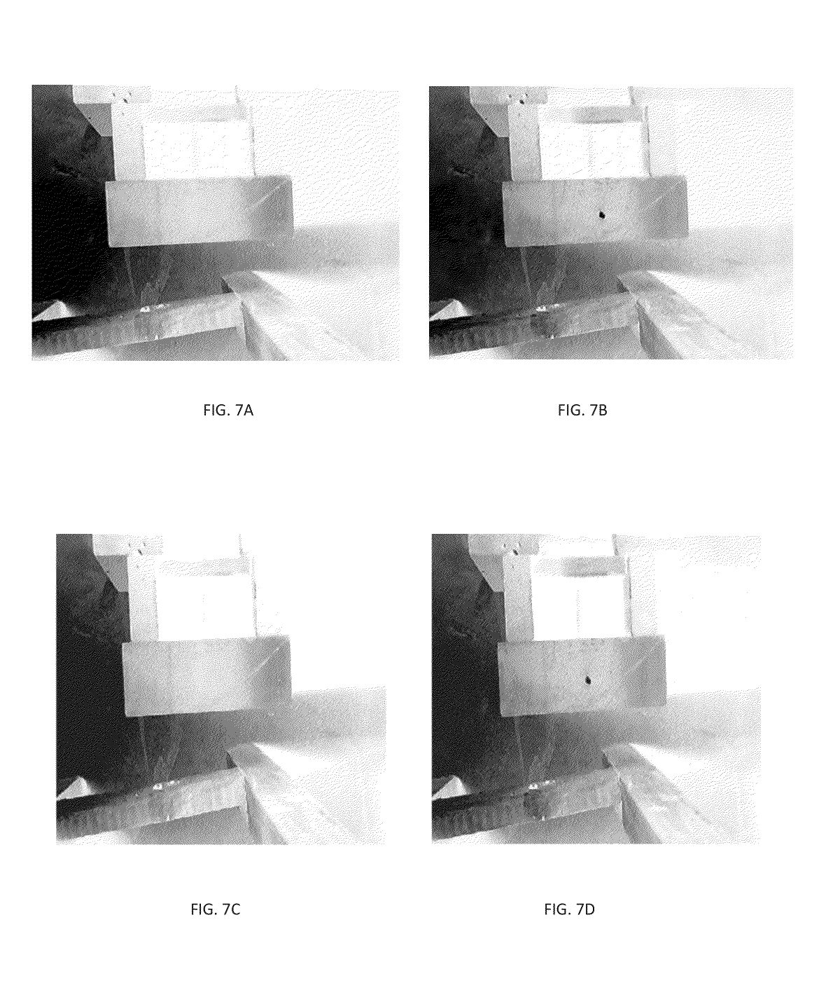

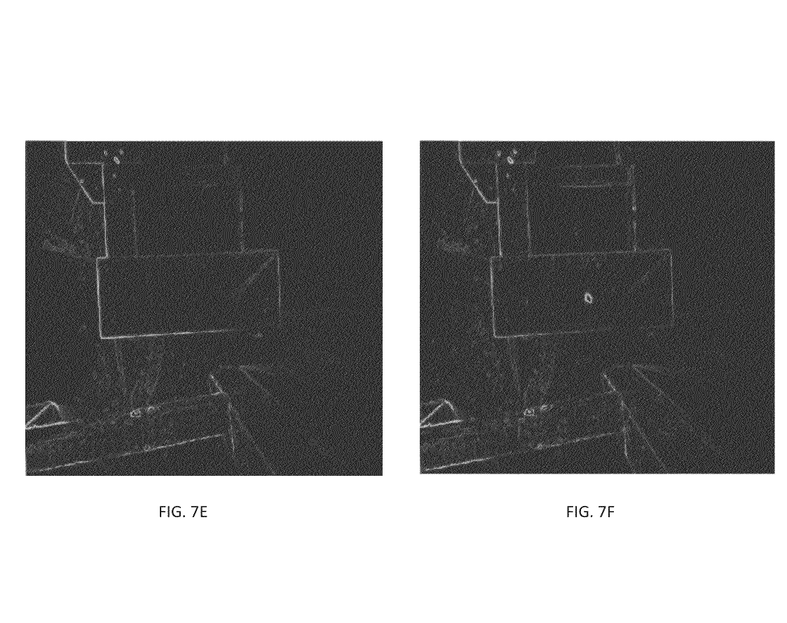

In one implementation, the optical data representing the reference sample and the optical data representing the stale sample are acquired at steps 310A, 340A with the use of the detection unit 210 of FIG. 2 in a, for example, VGA resolution mode with 24 bits of red-green-blue (RGB) information or in a high-definition mode registered by every pixel of the unit 210. Examples of images of the actual reference and stale samples acquired with the use of the system of the invention are shown in FIGS. 7A and 7B, respectively.

Such reference image (also referred to as a background image) and/or the stale image may be too large in size to be saved at the image processing unit. In this case the external memory storage 258 is used to save the image. Since writing image data to the external storage device 258 requires more clock cycles than writing image data to data storage space associated with the image processing unit 220, directly writing data to external storage device may not be preferred in order to meet certain time constrains. To solve this problem, two internal storage spaces in image processing unit may be used to buffer image data. In one example, the volume of internal storage is about 2.5 kBytes. The CCD sensor chip in the detection unit 210 transfers acquired image data line-by-line (in terms of pixels), to enable the image processing unit 220 to save current line in image to one internal storage space and transfer previous line in the other internal storage space to external storage space 258. After finishing saving the previous line, the image data in this internal storage space is expired. When data from the next line of pixels arrive, the image processing unit 220 saves it to internal storage space with expired data and transfers unsaved image data to external storage device 258.

The raw image data from the detection unit 210 includes data representing three channels of color information (R, G, and B). However, the presence of color in the image does not necessarily facilitate the identification of the edges in an image. Moreover, color of the sample as perceived by the detection unit 210 can be affected by environmental lighting and/or settings of the camera of the unit 210. Therefore, in one embodiment it may be preferred to eliminate the color content of the imaging data prior to further image data processing. For example, the data content of R, G and B channels of the unit 210 can multiplied or otherwise scaled, respectively, by different factors separately and then added together to map the polychromatic imaging data into a grayscale imaging data:

Grayscale=Factor1*R+Factor2*G+Factor3*B

Gray-scale images to which the images of FIGS. 7A and 7B have been converted are shown in FIGS. 7C and 7D, respectively.

After converting an image to a grayscale image, every image pixel can be represented, in a system 200, by 8 bit grayscale value. This will be also helpful for reducing algorithm complexity and shorten execution time of following steps. Such optional image data processing is equally applicable to imaging data representing the reference sample and imaging data representing the stale sample.

Referring again to steps 310, 340 of FIG. 3 and FIG. 4, the formation of the 2D-gradient images of the reference and stale samples may include, in addition to the optional conversion of the polychromatic images gray-scale images, the processing of the images of the reference and stale samples by carrying out an operation of convolution between a matrix representing a chosen filter with that of the image of the reference and stale samples, at steps 310C, 340C, respectively, to facilitate the finding of sample's edges in a given image.

Here, it is recognized that, regardless of whether a given image is mapped to a grayscale image or if it remains a polychromatic image for the purpose of imaging data processing, different samples may still be characterized by different grayscale values due to lighting changes and various reflections. Edge-related features of a sample however, are expected to be present and, therefore, imaged at any time regardless of the change in lighting conditions. It is from comparison of the sample edge(s) present in an image of the reference sample with those present in an image of the stale sample that a determination is made about FOD that the stale sample contains (if any).

In one implementation, edge(s) of the sample at hand are found by calculating the norm of a gradient vector at each pixel in the image of the sample. The gradient of the image shows a rate of change of the level of irradiance (represented by the image) at each pixel. In one implementation, two representations of a chosen operator or filter are convolved, respectively and in a corresponding one-dimensional (1D) fashion, as shown by steps 310C, 340C with an image of the sample formed at the preceding stage of the method of the invention to form two images each of which represent a 1D gradient of irradiance corresponding to the imaged sample. For example, it is appreciated that, if an operator S is used to carry out the convolution operation in one direction (for example, in a direction corresponding to the extend of a given image along x-axis), then a convolution in a transverse direction (for example, along y-axis) utilizes the S^{T} operator. The two resulting 1D-gradient images are then combined (for example, added on a pixel-by-pixel basis) at steps 310D, 340D when processing data representing the reference sample and the stale sample, to form respectively corresponding 2D-gradient images of the reference sample and the stale sample based on which the edge(s) associated with the reference and stale samples are further determined at steps 320, 350.

Referring again to FIGS. 3 and 4 and, in particular, to steps 310, 340, 320, 350, in one sample edge(s) can be found in a given image by using sobel operator (or mask, or filter) such as, for example, the one represented by matrix

$$S = [ \begin{matrix}- 1 & 0 & 1 \\ - 2 & 0 & 2 \\ - 1 & 0 & 1\end{matrix} ]$$

and, in a specific embodiment, by carrying out a 1D-convolution operation between such matrix corresponding to the sobel operator and the matrix representing the image in question to obtain an image representing the irradiance gradient in, for example, x-direction. If a sample edge is imaged by certain pixels, the level of irradiance at the image is expected to change substantially abruptly at those pixels. Then the norm of those pixels' irradiance gradient vector is likely to be higher than the norm of the irradiance gradient vector corresponding to other image pixels. In a similar fashion, the image of the sample representing an irradiance gradient in the y-direction may be obtained by 1D-convolution of the S^{T} matrix and the matrix representing the image in question. Then, the two images each of which represents a 1D-gradient of the irradiance distribution are added to form a 2D-gradient image. By analyzing a 2D-gradient image of a given sample a determination of the presence of sample's edge can be made.

In a specific embodiment, the sobel operator is configured to use the information from the pixels surrounding a given pixel to calculate the norm of the irradiance gradient vector at the given pixel, for each pixel. Accordingly, overall nine pixels are required to calculate a value of the gradient at one chosen imaging pixel. Taking into account image processing unit available resources and timing constrain, image processing unit can be configured to read out 48 pixels in 3 consecutive lines with 16 pixels in each line from the external storage device into local register every time, and them to calculate irradiance gradient value corresponding to 14 pixels using 14 sobel operators at the same time. Such configuration enables execution time that is about to about 1/14 compared to calculate norm of gradient vector of one pixel a time. Then the data representing the norm of the irradiance gradient vector is stored at the external storage device 258. FIGS. 7E, 7F represent 2D-gradient images corresponding, respectively, to the reference sample and the stale sample.

Following the formation of 2D-gradient images representing the reference sample and the stale sample, the identification of edge(s) of the sample being imaged at steps 320, 350 can involve a determination of a mean the irradiance gradient values for each of the 2D-gradient images. Such mean values serve as threshold values enabling the identification of a sample's edge. In particular, an edges is identified if the irradiance gradient value corresponding to a given image pixel is larger than the determined mean value. The mean value is calculated by averaging all norms of the irradiance gradient vector in a given image. Directly adding all gradient together may lead to overflow in image processing unit. To solve this problem, a mean value corresponding to every line in a given image is first calculated and saved to a data stack defined in the external memory storage device. The image processing unit is programmed to then read out mean values of each line from the data stack and averages them to calculate the mean of all pixels' gradients for a given 2D-gradient image.

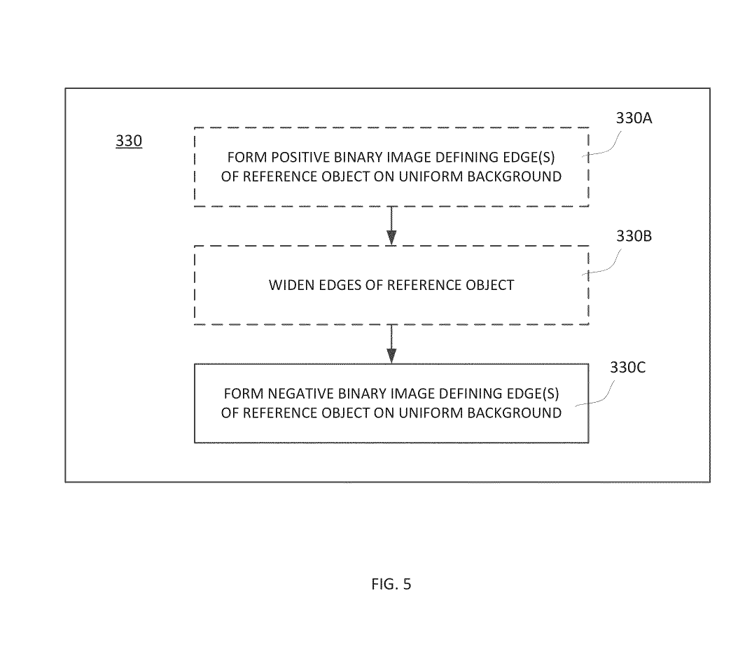

Optional sub-steps of the method of the invention related to step 330 of FIG. 3 are now discussed in detail in reference to FIG. 5.

The binary image of the sample is formed by mapping image data obtained at the preceding step of data processing algorithm into an image representing the sample in a binary fashion such that image pixels corresponding to the already-defined edge of the sample are assigned a first value and all remaining pixels are assigned another, second value that is different from the first value. In one implementation, the first value is zero and the second value is one. So defined, the binary image represents the edge(s) of the sample in a negative fashion (namely, the edge(s) are represented by (over)saturated pixels on the substantially dark or black background. Alternatively, the binary image of the sample can be formed by (i) first defining, at step 330A, a binary image representation of edge(s) in a “positive” fashion, wherein the image pixels representing the sample edge(s) are assigned a value of one and the remaining pixels of the image are assigned the value of zero, and (ii) inverting the so-defined positive binary image, at step 330C, to obtain a negative binary image.

In further reference to FIG. 5, optionally, sample edge(s) in the image—whether positive or negative binary image—can be spatially widened, at step 330B. Counter-intuitively, and as not recognized by related art (to the best knowledge of the inventors), such edge-widening data processing operation facilitates the compensation of image artifacts caused by the relative motion between the imaging camera and the sample and, therefore, enables more accurate and efficient determination of the presence of the FOD in the stale image. In practice, due to some relative motion between the sample and the camera, a shift of a few pixels may occur between the first moment of time (when the reference sample is being imaged) and the second moment of time (when the stale sample is being imaged). As a result, the very same edge of the sample can be represented, in an image of the reference sample and in an image of the stale sample, by not necessarily all of the same pixels but at least partially by the neighboring pixels. If edge “shifts” to a different position in an image during the time lapsed between the first and second moments of time in the image, two effective different edges will be identified (one in the image of the reference sample and another—in an image of the stale sample). The method of the invention compensates for such imaging artifact by widening edges in images by a few pixels to eliminate effects caused by possible camera shifting, to make that at least portions of the same edge(s) are represented by the same corresponding image pixels. In a specific implementation of the method of the invention, the process of edge-widening is implemented, at step 330B, by performing a 2D convolution between a binary image of the reference sample formed at step 330 and a “widening” operator such as, for example an 3×3 identity matrix. It is appreciated that the optional edge-widening step 330B can be carried out either with respect to a positive binary image of step 330A (if such step is present) or with respect to a negative binary image of step 330C.

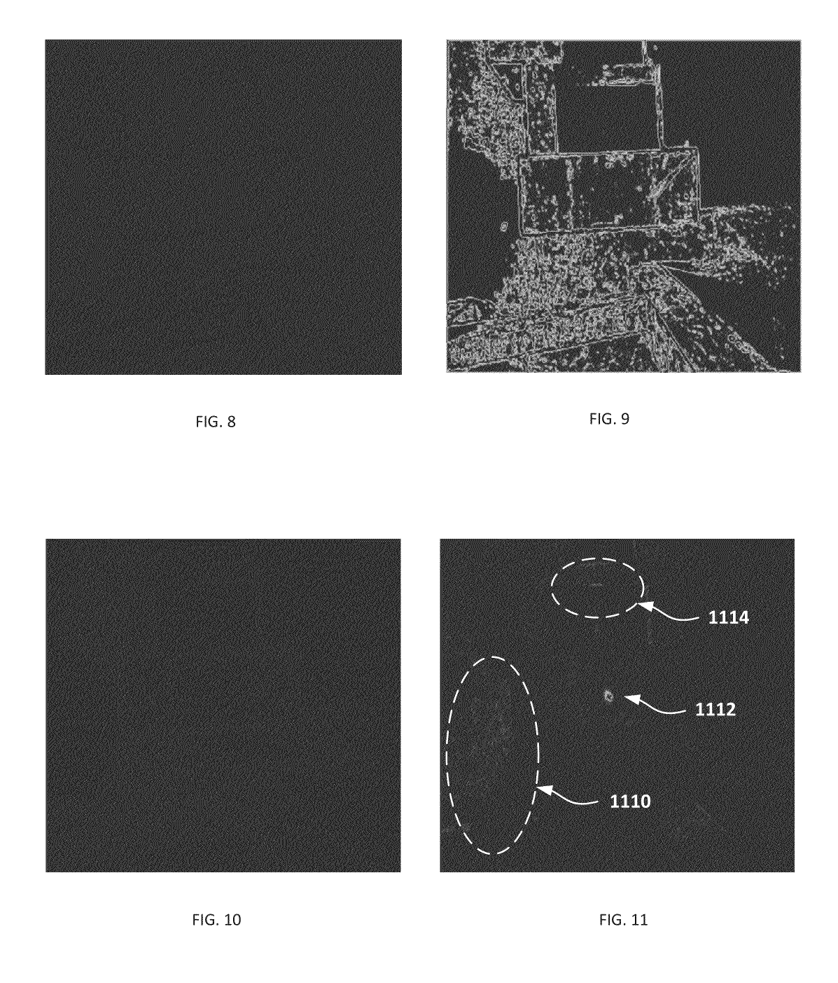

In one specific example, a respective value of irradiance gradient corresponding to each pixel of a 2D-gradient image of the reference sample obtained at step 310 is substituted to accelerate the speed of image data processing. The boolean value is used to represent whether a given pixel corresponding to the sample edge, as defined at step 320. The value of a pixel is replaced by 1 if the norm of its irradiance gradient vector is greater than the threshold value (predetermined as a mean of the irradiance distribution across the 2D-gradient image). Otherwise, the value of pixel is replaced by 0. As a result, after this step 330, the 2D-gradient image of the reference sample image representing sample edge(s) is converted to a binary image of the reference sample that distinguishes the sample edge(s) on a uniform image background. To this end, FIG. 8 illustrates a positive binary image representing edge(s) associated with the image (of the reference sample) of FIG. 7A obtained according to step 330A. Here, pixels identified in red are assigned a value of 1 and pixels identified in dark blue are assigned a value of 0. FIG. 9 illustrates a positive binary image of FIG. 8 in which the edge(s) have been widened, according to step 330B. FIG. 10 illustrates a negative, inverted binary image of the reference sample obtained from the image of FIG. 9 by re-assigning the values of image pixels according to step 330C.

Identification of image features specific to FOD and removal of “false positives”. Having obtained pre-processed images representing edge features of the reference and stale samples, the determination of the presence and significance of the FOD (if any) in the stale image is further carried out according to steps 360, 370 of FIG. 3.

At step 360, edge features that ostensibly represent the FOD at the stale sample are distinguished based on comparison between the binary image of the reference sample formed at step 330 and the 2D-gradient image of the stale sample. At this step, the operation of “edge subtraction” is performed, according to an image (of the stale object) is formed in which each pixel is assigned a value resulting from the multiplication of the value of the corresponding pixel of the negative binary image of step 330 and the 2D-gradient image identifying edges of step 350. As edge features of the negative binary image of step 330 are represented by zero-intensity pixels, and the edge feature of the image of step 350 are represented by pixels with value greater than zero, the edge features common to both images are effectively removed, and the so-formed resulting image of step 360 contains edge features that are specific only to the stale object.

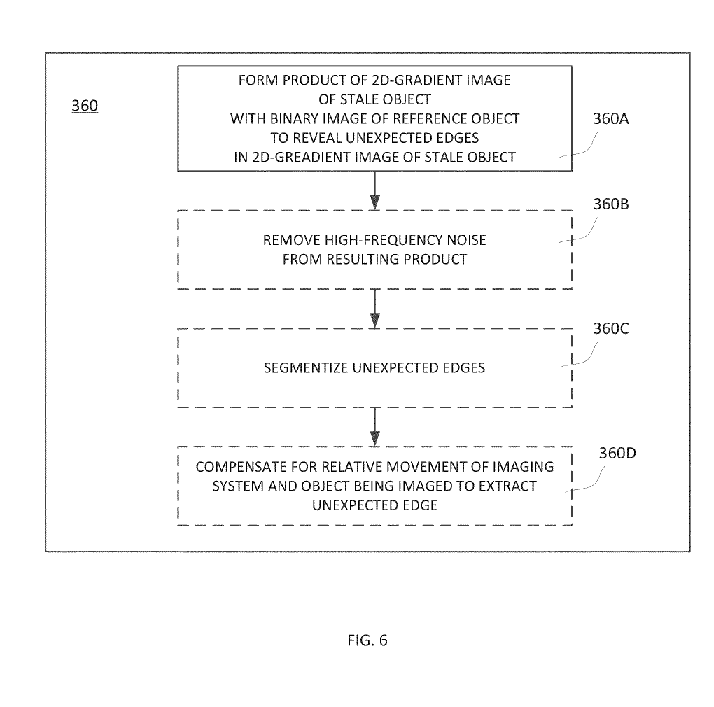

In reference to the related FIG. 6, the step 360 of identifying edge features of the FOD may include forming a product of the 2D-gradient image of the stale object and a (negative) binary image representing edge features of the stale object, at step 360A. Additional data processing may optionally include removing the high-frequency noise, at step 360B, from the resulting “product image” of step 360A, by passing the imaging data output from step 360A through a low-pass filter. The optional use of the low-pass filtering of the imaging data is explained by the fact that, due to different conditions of acquisition of the two initial images of FIGS. 7A and 7B, some high frequency features may remain present even after the “edge subtraction” operation. The low-pass filtering process is implemented, for example, by performing a 2D-convolution between an image resulting from step 360A and a low-pass filter operator. As a result, the edge-features 1110, 1112, 1114 that are suspect FOD are emphasized.

The FOD-identification of step 360 may additionally include a step 360C at which the suspect edge-features 1110, 112, 1114 are segmented. At this step, some of image pixels corresponding to suspect features 1110, 1112, 1114 that do not, in practice, correspond to the edges of the FOD, may have higher value of gradient of intensity and still remain in the image. To further remove these noise pixels in the image, the image is segmented (compared with another threshold value chosen for example, between the value corresponding to the image mean as defined at step 350 and a maximum value of irradiance corresponding to the image of the stale object). Any pixel with value greater than the so-defined threshold is assigned a chosen value (for example, a value of 1), and the remaining pixels are assigned another chosen value (for example, the value of zero). The imaging data corresponding to the segmented image of step 360C is stored at external storage device 258.

Another optional sub-step step of the FOD-identification of step 360-step 360D—was found to unexpectedly facilitate the compensation of the relative motion between the imaging system and the sample that occurs during the time lapsed between the acquisition of the image of FIG. 7A image of the reference sample) and the acquisition of the image of FIG. 7B (image of the stale sample). Specifically, some noise data caused by, for example, camera shifting may still remain on image. In particular, since at least some of the edges associated with the reference sample have been widened at a preceding step of image data processing, at least a portion of such widened edges can remain in the segmented image of step 360C. An 3-by-3 window (erosion matrix, for example an identity matrix) is applied to the binary image resulting at the previous step(s) of image processing to effectuate a 2D convolution between the erosion matrix and the image formed at the preceding step. If, as a result of a convolution operation, the value of irradiance associated with a given pixel of the convolved image is less than a predetermined threshold, such pizle is assigned a value of zero. Otherwise, such pixel is assigned a value of one. At the output of this “image erosion” step, the FOD is identified with substantially high probability and certainty as only the edges associated with the FOD remain in the image.

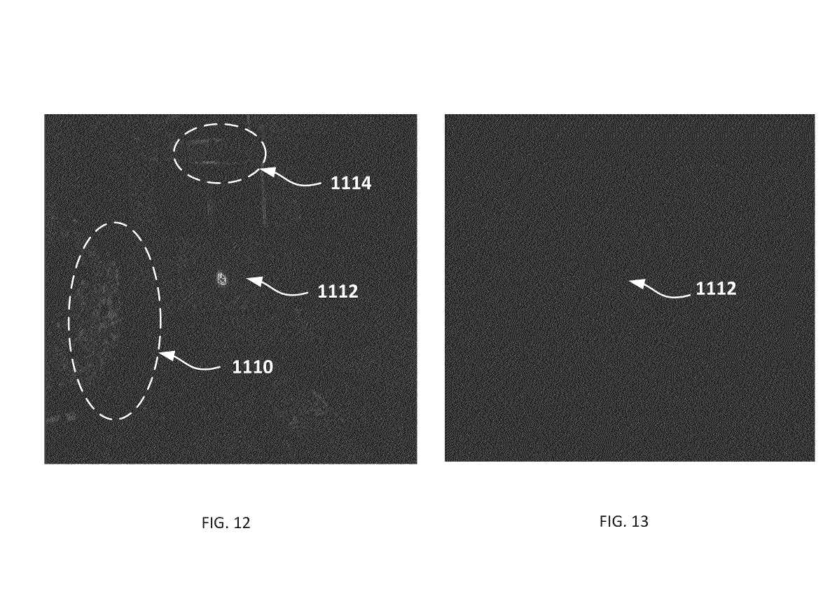

One example of the image formed according to step 360 of FIG. 3 (and/or corresponding sub-steps of FIG. 6) and based on the comparison of the images of FIGS. 10 and 7F is shown in FIG. 11. Here, the edge features 1110, 1112, 1114 are specific to the stale image of FIG. 7B and, therefore, to the stale object forming the image of FIG. 7B. At least one of the edge features 1110, 1112, 1114 is suspect with respect to the FOD. The image of FIG. 11, transmitted through a low-pas filter according to step 360B of the method, is shown in FIG. 12. The low-pass filter operation chosen in this example included the one represented by the matrix

$$[ \begin{matrix}0.75 & 1.00 & 0.75 \\ 1.00 & 1.5 & 1.00 \\ 0.75 & 1.00 & 0.75\end{matrix} ]$$

When the chosen low-pass filter operator contains decimals but the image processing unit does not directly support operations involving decimals, the values characterizing the low-pass filter can be converted to integers by multiplying by 128, for example. The segmented version of the image of FIG. 12 was obtained according to step 360C with the use of a threshold value defined as the function of (i) the average value of the irradiance of the image resulting at step 360B and (ii) the maximum value of the irradiance of that image according to

threshold=average value+0.5(average irradiance value+0.9*maximum irradiance value).

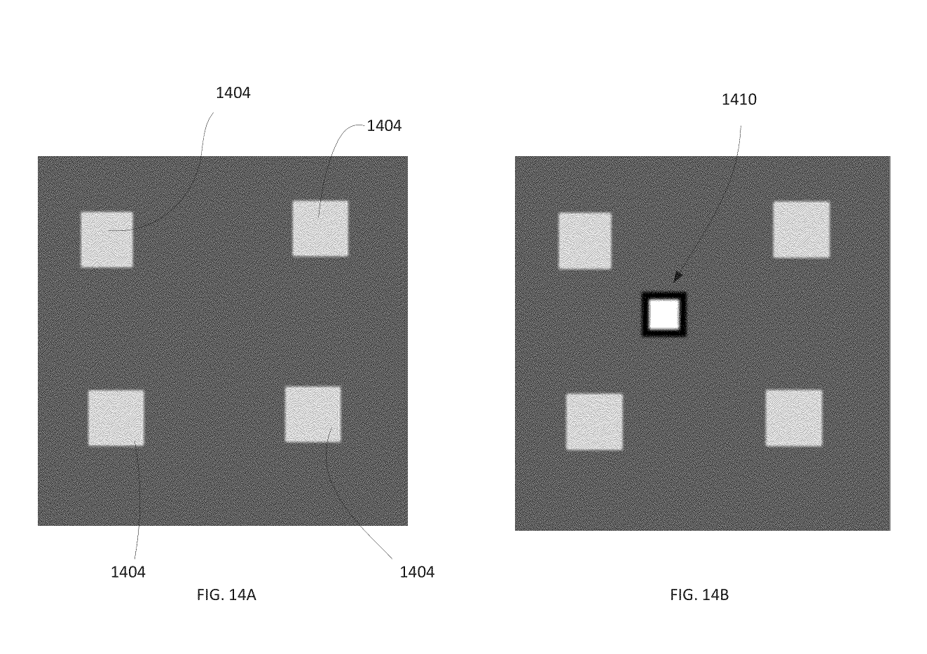

The so segmented image was then “eroded” according to the step 360D with the use of the 3-by-3 identity matrix to compensate for the relative movement between the imaging system and the sample, is shown in FIG. 13. It can be seen that, as a result of segmenting the image of FIG. 12, the false-positive suspects of FOD features 1110, 1114 have been removed from the image of the stale sample.

In further reference to FIG. 3, the embodiment of the method of the invention may additionally contain yet another step 370, at which the identified FOD is filtered according to its size to determined whether this FOD is of any operational importance and whether the sample under test has to be cleaned-up to remove/repair a portion of the sample associated with the FOD. At this step, the size of the identified FOD 1112 is calculated and compared to pre-determined threshold values. If size of the FOD is too large or too small, the FOD may be considered to be of no substantial operational consequence and neglected. It is appreciated that at this or any other step of the method of the invention, the processor 220 of the system (of FIG. 2) may generate a user-perceivable output such as a sound-alarm or a light-indicator that provides an input, to the user, that a particular determination related to the identification of the FOD in the image of the stale sample has been made. For example, and in connection to the step 370, the processor-governed alarm can be generated to indicate that the size of the identified FOD 1112 falls within the range of sizes that require special attention by the user.

### ADDITIONAL EXAMPLES

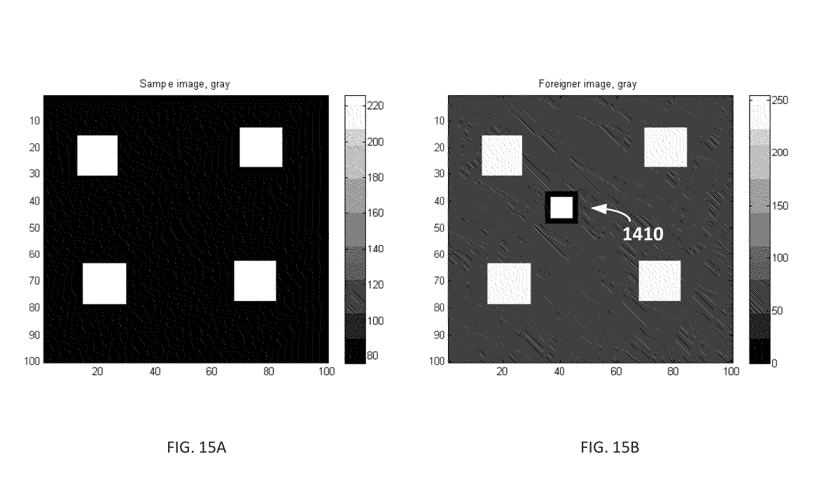

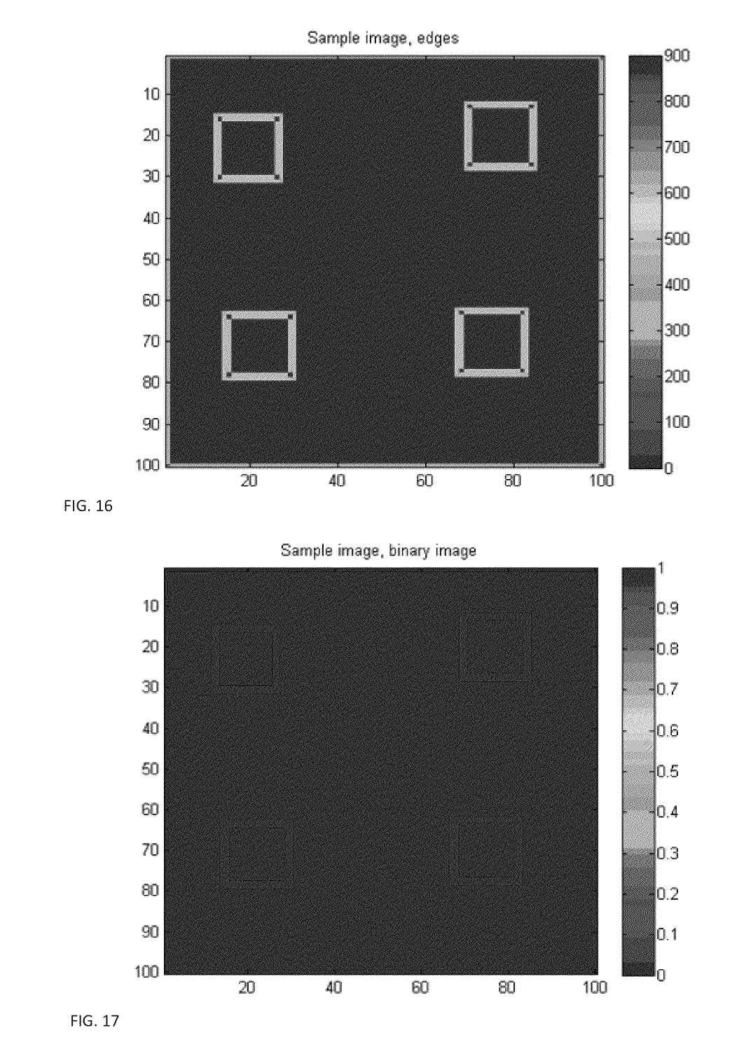

Additional examples of image data processing according to the above-describe embodiment of the invention is further presented in FIGS. 14 through 24. Here, FIGS. 14A and 14B provide examples of images of chosen reference and stale samples acquired with an imaging system of the invention, the stale sample containing an FOD 1410. The reference sample is chosen to be a combination of four squares on a substantially uniform background, and the FOD is chosen to be another square feature in the middle portion of the sample. FIGS. 15A, 15B represent gray-scale image images corresponding to the images of FIGS. 14A, 14B and obtained, according to an embodiment of the invention, with the use of Factor 1=0.299; Factor 2=0.587; Factor 3=0.114. FIG. 16 is an image identifying edge-features of the chosen reference sample of FIG. 14A and obtained with the use of the following sobel operators: for forming an image of the reference sample representing x-gradient of irradiance distribution, the matrix

$$S = [ \begin{matrix}- 1 & 0 & 1 \\ - 2 & 0 & 2 \\ - 1 & 0 & 1\end{matrix} ]$$

was used; for forming an image of the reference sample representing y-gradient of irradiance distribution, the matrix

$${S}^{T} = [ \begin{matrix}- 1 & - 2 & - 1 \\ 0 & 0 & 0 \\ 1 & 2 & 1\end{matrix} ]$$

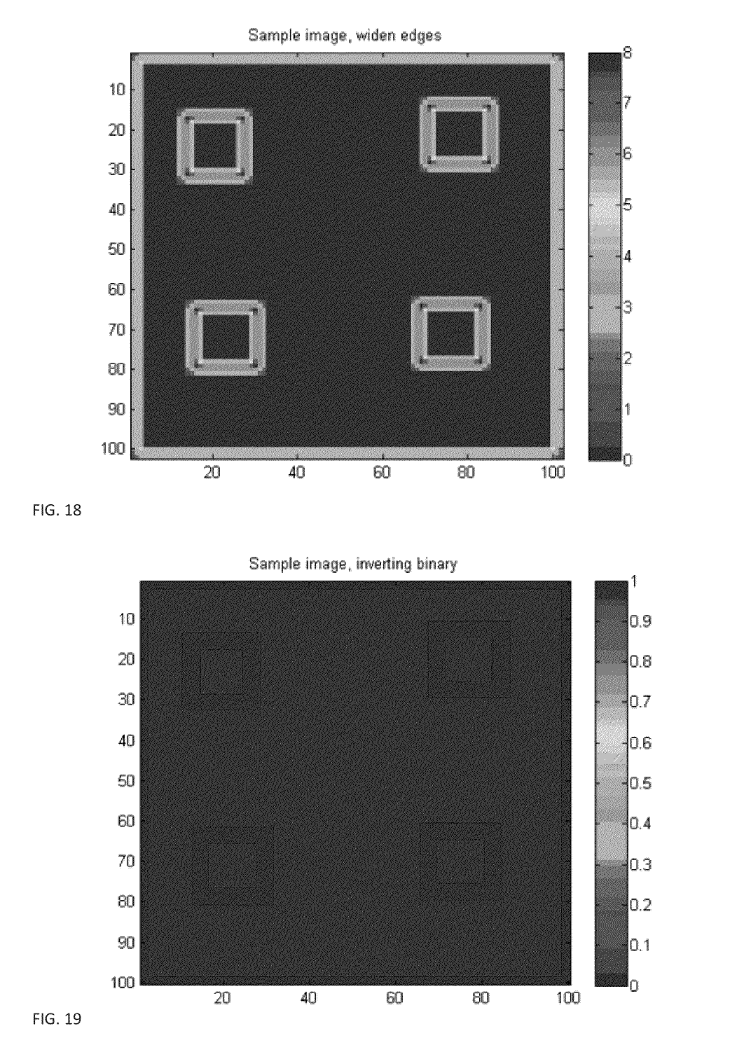

according to an embodiment of the invention. FIG. 17 is a positive binary image corresponding to the image of FIG. 16 and obtained as discussed above. FIG. 18 is the positive binary image of FIG. 17 in which the edge-features have been spatially widened according to an embodiment of the invention discussed above. FIG. 19 is a negative (inverted) binary image representing the reference sample of FIG. 14A.

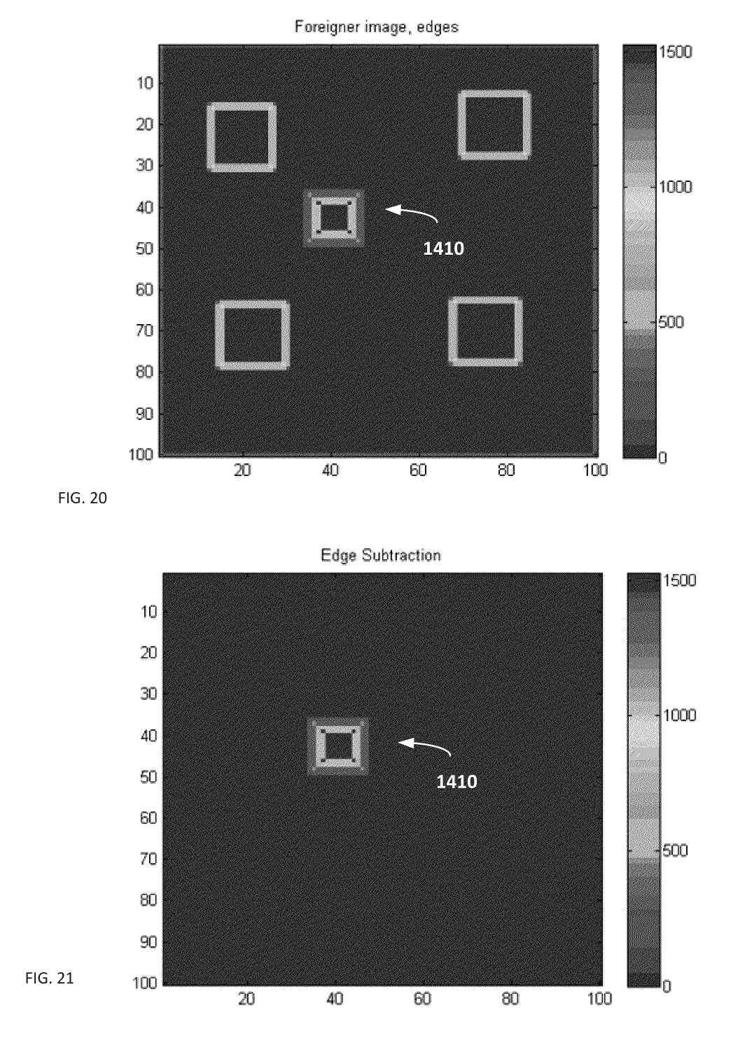

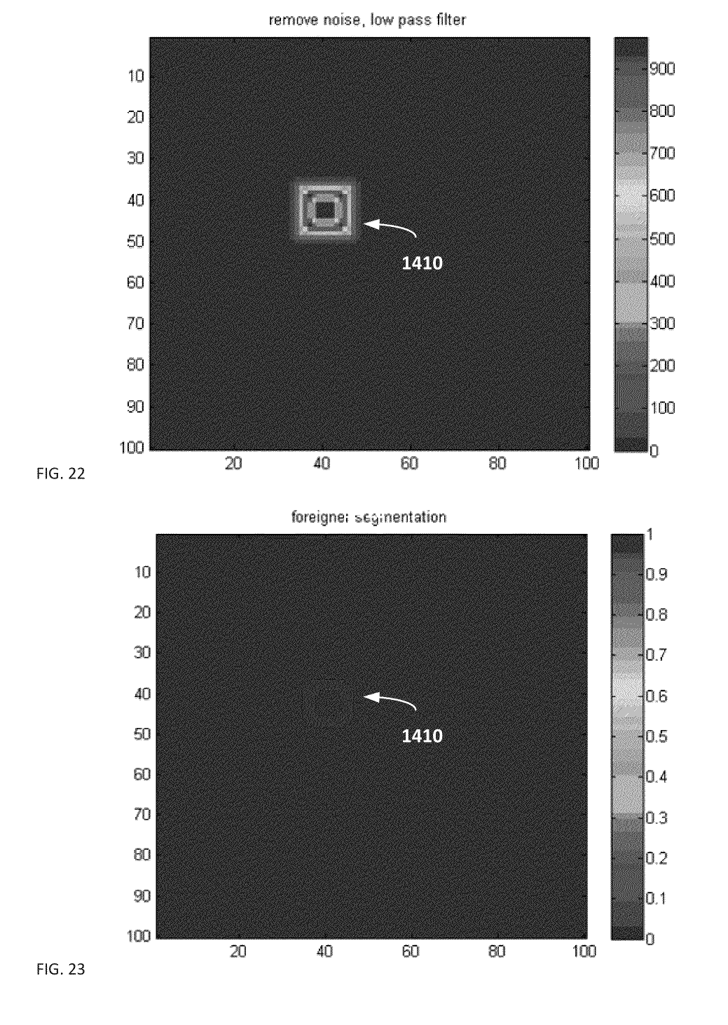

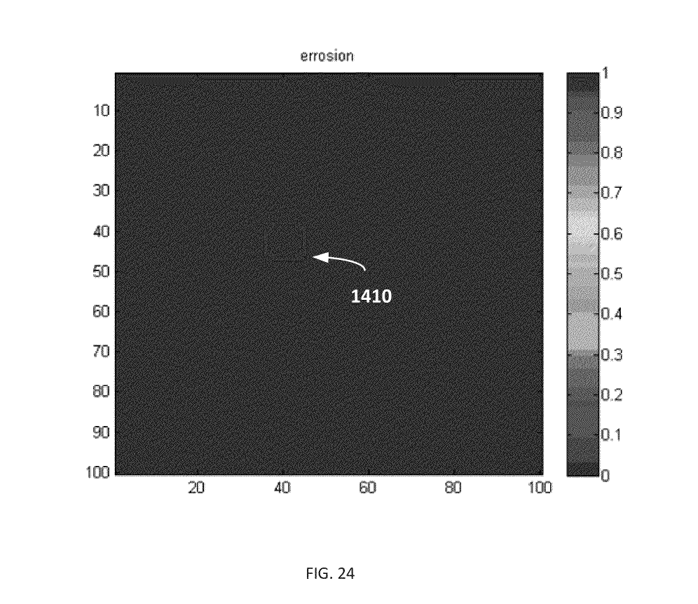

FIG. 20 is an image identifying edge-features of the chosen stale sample of FIG. 14B and obtained, according to an embodiment of the invention, with the use of matrices S and S^{T} used to obtain the results of FIG. 16. FIG. 21 is an image formed from the image of FIG. 20 by implementing an edge-subtraction step of the embodiment of the invention and identifying a suspect FOD. FIG. 22 is the image of FIG. 21 from which the high-spatial frequency noise has been removed. FIG. 23 is the image of FIG. 22 that has been segmented according to an embodiment of the invention. Finally, FIG. 24 is an image positively identifying the FOD of the stale sample of FIG. 14B after compensation for relative movement between the sample and the imaging system of the invention has been performed accruing to an embodiment of the invention.

It is appreciated that a system of the invention includes an optical detector acquiring optical data representing the surface of the object of interest through at least one of the optical objectives and a processor that selects and processes data received from the detector and, optionally, from the electronic circuitry that may be employed to automate the operation of the actuators of the system. Accordingly, implementation of a method of the invention may require instructions stored in a tangible memory to perform the steps of operation of the system described above. The memory may be random access memory (RAM), read-only memory (ROM), flash memory or any other memory, or combination thereof, suitable for storing control software or other instructions and data. In an alternative embodiment, the disclosed system and method may be implemented as a computer program product for use with a computer system. Such implementation includes a series of computer instructions fixed either on a tangible non-transitory medium, such as a computer readable medium (for example, a diskette, CD-ROM, ROM, or fixed disk) or transmittable to a computer system, via an interface device (such as a communications adapter connected to a network over a medium). Some of the functions performed during the execution of the method of the invention have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. In addition, while the invention may be embodied in software such as program code, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

The invention should not be viewed as being limited to the disclosed embodiment(s).

What is claimed is:

1. A method for determining a foreign object debris (FOD) associated with a sample, the method comprising:
a) with a detector of an imaging system, acquiring reference image data representing the reference sample to form a reference gradient image, of the reference sample, each pixel of which represents a value of a two-dimensional (2D) gradient of irradiance distribution associated with the reference sample;
b) determining reference edge image data representing a position of an edge associated with the reference sample based on the reference gradient image data;
c) forming a reference binary image data by
assigning a first value to first pixels of the reference gradient image data that correspond to the edge associated with the reference sample, and
assigning a second value to the remaining pixels of the reference gradient image, the second value being different from the first value;
d) forming an inverted reference binary image by defining a negative of the reference binary image created from the reference binary image data.
e) based on acquisition of an image of a stale sample with the imaging system and determination of a 2D gradient of irradiance distribution associated with said image, forming an image of the stale sample that displays an edge associated with the stale sample;
f) combining, with a processing unit, the inverted reference binary image with the image of the stale sample to form a comparison image, said comparison image being devoid of an edge that is associated with both the reference sample and the stale sample.

2. A method according to claim 1, wherein the determining reference image data includes identifying first data points the values of which exceed a mean irradiance value associated with the reference gradient image.

3. A method according to claim 1, wherein the determining reference edge image data includes determining reference edge image data based on the reference gradient image converted to represent a gray-scale image of the reference sample.

4. A method according to claim 1, wherein the forming of an image of the stale sample includes forming an image of the stale sample based on data representing a gray-scale image of the stale sample.

5. A method according to claim 1, further comprising applying a low-pass filter to the comparison image to form a resulting low-frequency image, and mapping a resulting low-frequency image into a segmented binary image based on pixel-by-pixel comparison between the resulting low-frequency image and a predetermined threshold value.

6. A method according to claim 5, further comprising two-dimensionally convolving a data matrix representing the segmented binary image with an image erosion matrix.

7. A method according to claim 1, wherein the forming of an inverted reference binary image includes defining a negative of the reference binary image in which each edge associated with the reference sample has been spatially widened.

8. A method according to claim 1, further comprising widening of at least one edge associated with the reference sample by convolving, in two-dimensions, an identity matrix with a matrix representing the reference binary image.

9. A method according to claim 1, further comprising extracting an edge of the FOD from the comparison image that has been compensated for a relative movement between the imaging system and the stale sample and disregarding the FOD when a size of the FOD calculated based on the extracted edge of the FOD falls outside of a range of interest.

10. A method for determining a foreign object debris (FOD) associated with a sample, the method comprising:
a) with a detector of an imaging system, acquiring reference image data representing a reference sample to form a reference image;
b) forming an image of the reference sample representing a position of an edge associated with the reference sample based on (i) a first image of said reference sample representing a first change of irradiance distribution associated with said reference sample and (ii) a second image of said reference sample representing a second change of irradiance distribution associated with said reference sample, the first and second changes occurring in mutually transverse directions;
c) converting the image of the reference sample representing a position of an edge associated with the reference sample into a binary image of the reference sample, said binary image containing edges associated with said reference sample on a uniform background;
d) forming an image of a stale sample representing a position of an edge associated with the stale sample based on (i) a first image of the stale sample and (ii) a second image of the stale sample, the first image representing a first change of irradiance distribution associated with the stale sample and the second image representing a second change of irradiance distribution associated with the stale sample, the first and second changes occurring in mutually transverse directions;
e) forming a comparison image of the sample, which comparison image is devoid of an edge that is associated with both the reference sample and the stale sample, based on the binary image of the reference sample and the image of the stale sample;
f) determining if the FOD is present at the stale sample by compensating the comparison image for a relative movement between the stale sample and the imaging system and comparing pixel irradiance values of the comparison image with a predetermined threshold value.

11. A method according to claim 10, further comprising widening of at least one edge associated with the reference sample by convolving, in two-dimensions, a chosen matrix with a matrix representing the binary image of the reference sample.

12. A method according to claim 10, further comprising size-filtering of the FOD.

13. A method according to claim 10, wherein the converting includes assigning an irradiance value of zero to pixels of edges associated with said reference sample and an irradiance value of one to remaining pixels of the image of the reference sample representing a position of an edge associated with the reference sample.
